(19) United States
(12) Patent Application Publication
(10) Pub. No.: US 2016/0332853 A1
(43) Pub. Date: Nov. 17, 2016

(54) Inground Lifting System with a Modular Structure for Lifting a Vehicle, and Method There For

(71) Applicant: STERTIL B.V., Kootstertille (NL)

(72) Inventor: Jan Willem Fijnvandraat, Leeuwarden (NL)

(21) Appl. No.: 15/111,309

(22) PCT Filed: Jan. 7, 2015
(86) PCT No.: PCT/NL2015/050008

§ 371 Date: Jul. 13, 2016

Related U.S. Application Data
(60) Provisional application No. 61/927,067, filed on Jan. 14, 2014.

(30) Foreign Application Priority Data
Jan. 14, 2014 (NL) 2012085

(51) Int. Cl. B66F 7/28; B66F 7/16

(52) U.S. Cl. CPC B66F 7/28; B66F 7/16

(57) ABSTRACT

The invention disclosed is an inground lifting system for lifting a vehicle and a method for configuring an inground lifting system. The lifting system according to the invention includes a pit provided with one moveable first lifting device, a second lifting device, and a cover configured for covering the pit. The pit further includes a pit frame. The pit frame includes a modular cover guidance structure configured for guiding the cover.

The invention relates to an inground lifting system and more specifically to a system comprising one or more moveable lifting devices. These inground lifting systems are specifically used for lifting trucks, busses and/or vehicles.

Conventional inground vehicle lifting systems comprise a moveable lifting device that is maneuvered under an axle of the vehicle, like a bus or truck, in accordance with the specific axle distance of the vehicle. To deal with different axle distances the moveable lifting device is moved in a pit. A cover is provided to cover the opening of the pit and to provide a safe working place when performing service or maintenance operations such as tire or brake replacement, or other tasks that require access to the under side of the vehicle. Every time the lifting device repositions the cover moves accordingly. These conventional inground lifting systems are custom made, thereby resulting in complex and relatively expensive lifting systems.

An objective of the present invention is to obviate or at least to reduce the above problems and to provide a lifting system that is economically more feasible.

This objective is achieved with an inground lifting system for lifting a vehicle according to the invention, the inground lifting system comprising:
a pit provided with one moveable first lifting device, the pit comprising a pit frame;
a second lifting device; and
a cover configured for covering the pit,
wherein the pit frame comprises a modular cover guidance structure configured for guiding the cover.

The invention relates to a so-called inground lifting system. Such vehicle lifting system preferably comprises a first lifting device with a stationary position that is used for lifting the front, or alternatively the rear, of the vehicle to be lifted. The inground lifting system further comprises one or more moveable lifting devices for lifting the other part(s) of the vehicle. The one or more moveable lifting devices are provided in a pit to enable a translational movement of the moveable lifting devices. In use this movement is substantially in a lengthwise direction of the vehicle to be lifted. By enabling such translational movement for one or more moveable lifting devices a wide range of vehicle dimensions can be dealt with in the lifting system according to the present invention.

The inground lifting system is provided with a pit cover. Preferably, the moveable lifting device is connected to the pit cover such that the pit remains covered during the operation, and more specifically remains covered during translational movement of the moveable lifting device.

Preferably, the vehicle is lifted by the lifting device engaging one of the wheel axles of the vehicle. The one or more moveable lifting devices are positioned relative to the different vehicle axles. This achieves an effective and efficient positioning of the moveable lifting devices and enables lifting of a vehicle. Optionally a vehicle wheel base distance measuring system is used for determining the desired location(s) for the one or more moveable lifting devices.

The inground lifting system preferably comprises a drive that is configured for driving the moveable lifting device or devices. In a presently preferred embodiment, this drive involves a toothed gear-rack to move the inground lifting devices in a conventional manner, or, alternatively, the drive enables moving of the moveable lifting device by pulling the pit cover that preferably is connected to the carriage of the moveably lifting device. Such cover drive that is provided in such alternative embodiment would be capable of driving the cover such that the cover moves the carriage and the moveable lifting device can be moved between different positions within the range of travel of the lifting device in the pit. In such an alternative embodiment movement of the cover is preferably achieved by applying pulling forces only. By pulling the cover, the cover can be moved jointly and locking and/or undesired upward folding of the cover or cover part thereof, is substantially prevented.

The inground lifting system according to the present invention comprises a modular cover guidance structure that is configured for guiding the cover. This modular guidance structure provides a modular means that can be applied to a wide range of inground lifting systems. This significantly reduces the amount of labour and costs associated with materials for lifting systems that are customer specific designed. This modular cover guidance structure enables an inground lifting system that is more economically feasible.

A further advantage of the inground lifting system according to the present invention is the possibility to incorporate the system in existing pits. This would only require removal of relevant parts of the old lift. The pit does not require any significant modifications as guiding of covers and cable carriers are directly attached to the new system. This provides a cost effective system for upgrading any existing pit.

Preferably, the pit of the inground lifting system according to the present invention comprises a number of modular pit structures that together define the pit. When designing a specific inground lifting system use can be made of a number of these modular pit structures. Preferably these modular pit structures are available having a different length as seen in the lengthwise direction of the vehicle to be lifted when in use. Especially the combination of modular cover guidance structures and modular pit structures results in an effective inground lifting system that can be designed cost effectively as compared to conventional lifting systems. In a presently preferred embodiment the dimensions of the modular pit structures have been chosen that such pit structures can be easily transported involving a standard type container, for example. For example, the use of about five different dimensions for separate modular pit structures already appears to enable providing a large variation of inground lifting system dimensions that would be capable of dealing with wheel base distances varying in the range of 1.2 to 12 m, for example. It will be understood that also other dimensions would be available within the range of the present invention.

In a presently preferred embodiment according to the present invention the guidance structure is releasable connected with a connection to the pit frame.

By releasable connecting the modular guidance structure to the pit frame with a releasable connection an easy implementation of the cover and guidance structure is provided. This results in an effective mounting or installation operation for the inground lifting system according to the present invention.

Preferably, the connection comprises a snap connection using a so-called snap profile. More specifically, the snap profile according to a preferred embodiment is arranged at or close to the modular guidance structure or profiles thereof, and a corresponding snap rod is preferably arranged on a pit frame or attached thereto. In an alternative embodiment the snap profile may be arranged on or close to the pit frame and the snap rod be attached to the modular guidance structure. The releasable connection provides an easy to implement modular guidance structure when installing an inground lifting system according to the present invention.

In a presently preferred embodiment according to the present invention the snap rod comprises a number of rod elements that are arranged in a lengthwise direction of the pit. Providing a number of rod element as an alternative to a snap rod extending over substantially the entire pit length installation is made more convenient.

In a presently preferred embodiment according to the present invention the cover comprises a rolling cover.

By providing a rolling cover a flexible element covering the pit opening is provided resulting in a safe working environment. Although the cover itself may relate to a conventional cover, such cover in the inground lifting system according to the present invention is guided by a modular cover guidance structure. In a presently preferred embodiment the pit guidance structure comprises a continuous guiding structure for the rolling cover. This means that the guidance structure runs continuous from both sides of the moveable lifting device through the pit structure. Optionally, the cover elements that are provided on opposite sides of the moveable lifting device are connected to each other with their ends. Alternatively, the ends remain free and unconnected. Obviously, this may typically depend on the dimensions of the pit and inground lifting system.

In a presently preferred embodiment according to the present invention the cover of the inground lifting system comprises a number of plate covers.

The plate covers itself may relate to conventional plate covers. However, the plate covers are arranged such that they are capable of being guided by the modular cover guidance structure of the inground lifting system according to the present invention. The use of such plate covers provides a cost effective alternative to the use of rolling covers.

In a presently preferred embodiment the plate covers comprise interacting contact elements that enable joint movement of the plate covers. Only one plate cover needs to be driven by preferably the moveable lifting device as this cover may drive one ore more of the other plate covers, if required. Obviously, this depends on the actual location of the moveable lifting device in the pit.

With the modular cover guidance structure according to the present invention it would typically be possible to provide the modular cover guidance structure arranged for guiding a cover of one type, for example plate covers. Whenever applicable, the modular cover guidance structure can easily be replaced by a modular cover guidance structure configured for another type, for example for guiding a rolling cover. This provides flexible means to amend or change the inground lifting system according to the present invention. This change may relate by replacing the plate covers by the rolling cover. This provides additional flexibility to the user of the inground lifting system according to the present invention. Such change with the inground lifting system according to the present invention would not require any further amendment to the lifting system or pit structure besides a change of the modular cover guidance structures, or a profile thereof, and the desired cover type. In addition, through the use of modular pit structures it would be possible to redesign or even relocate the entire lifting system according to the invention. This provides a cost effective alternative to installing a new pit and lifting device.

In an alternative embodiment according to the present invention the cover of the inground lifting system may comprise at least one rolling cover and one set of plate covers. This provides additional flexibility for the user of the inground lifting system.

In a presently preferred embodiment according to the present invention the inground lifting system further comprises a spacer module that is arranged between the first and second lifting system.

By providing a spacer module, preferably a modular spacer module, the distance between two lifting devices of the lifting system according to the invention can be designed in accordance with the desired specifications. In a presently preferred embodiment according to the present invention, a spacer module is provided between a moveable first lifting device in a pit and a second lifting device provided in a stationary position. The spacer module is provided between the two lifting devices thereby defining the minimal distance between the two lifting devices and the according minimal wheel base distance or distance between the two axles of a vehicle to be lifted.

Preferably, the spacer module comprises a top plate and the spacer module is configured for receiving one or more plate covers. By providing a top plate the spacer module provides a safe working environment. Preferably, the plate covers provided on one side of the moveable lifting device can be received by the spacer module and preferably be stored underneath the top plate of the spacer module. Preferably, the size of the plate covers is determined by the size of the top plate of the spacer module. This provides an effective cover of the pit that provides a safe working environment. Optionally, a spacer or end module is also provided on the other side of a moveable lifting device in a similar manner.

In a presently preferred embodiment according to the present invention the inground lifting system comprises a base plate having an adjustable pick-up adapter configured for engaging a vehicle axle, with the adapter comprising a lever arm configured for adjusting a position of the adapter.

Conventional inground lifting systems comprise a base plate. To enable handling different wheel axles adapters are used. The adapters are mounted on the base plate corresponding to the dimensions of the wheel axle to be lifted. According to the present invention there is provided a lever arm enabling remote adjustment of the adapter. This enables the user or operator to adjust the adapter not only before the vehicle to be lifted is positioned relative to the lifting system, but also after positioning the lifting system and the vehicle to be lifted relative to each other. This renders the adjustment of the adapter more flexible and any corrections less labour intensive. In a presently preferred embodiment the lever arm can be engaged with a rod or arm. For the engagement the rod or arm is preferably provided with a ring, eyelet or other contact means that preferably engages on a knob, button or other contact element that is provided on the lever arm. Optionally, the rod or arm is extendible.

Preferably, the adapter further comprises at least one spring element arranged for maintaining the adapter in a correct position. In addition, the spring element is preferably arranged to provide an auxiliary force acting in a substantial direction to assist adjusting the adapter from the starting/horizontal/flat position. In a presently preferred embodiment the spring element is a torsion spring. Optionally other type of spring elements can be applied as alternative or in combination with the spring element. Preferably two torsion springs are provided in each adapter to achieve a stable and robust adapter.

In a further preferred embodiment according to the present invention at least one of the lifting devices comprises a piston type lifting device.

A (telescopic) piston type lifting device is preferably applied when a sufficient depth of the pit is available.

In an alternative embodiment of the inground lifting system according to the present invention at least one of the lifting devices comprises a scissor type lifting device. Such scissor type lifting device has the additional advantage that a relatively shallow pit construction can be used or applied. This would be beneficially in situations with bedrock, water table or unstable soil conditions.

Both types of lifting devices accommodate vehicles with relatively low ground clearance. It will be understood that also combinations of different types of lifting devices would be possible in the inground lifting system according to the present invention.

Optionally, the inground lifting system according to the present invention is provided as a so-called flush type lifting system wherein a bolster of the lift in a retracted position is more or less flush with a floor of the work place. This has advantages when working with relatively low vehicles having a relatively small distance between the work floor and the vehicle bottom. Such systems could be provided with pockets at a specific location such that in the retracted position the lifting system has to provide the moveable lift in this specific location. Alternatively, the system is provided with a continuous system wherein the bolster can move over the entire moving distance of the pit and be retracted at any desired position. A non-flush type system provides a bolster that in the retracted position remains above the floor surface. It will be understood that the choice for a specific type of lifting system can be made in accordance with consumer preferences.

The invention further relates to a method for configuring an inground lifting system as described above, the method comprising the steps of:
defining the dimensions of the lifting system;
determine the number and type of modular pit structures together defining a pit of the lifting system;
placing and connecting the pit structures;
providing a modular cover guidance structure; and
positioning a cover.

The same effects and advantages apply for the method as described for the system.

Further advantages, features and details of the invention will be elucidated on the basis of preferred embodiments thereof, wherein reference is made to the accompanying drawings, in which:

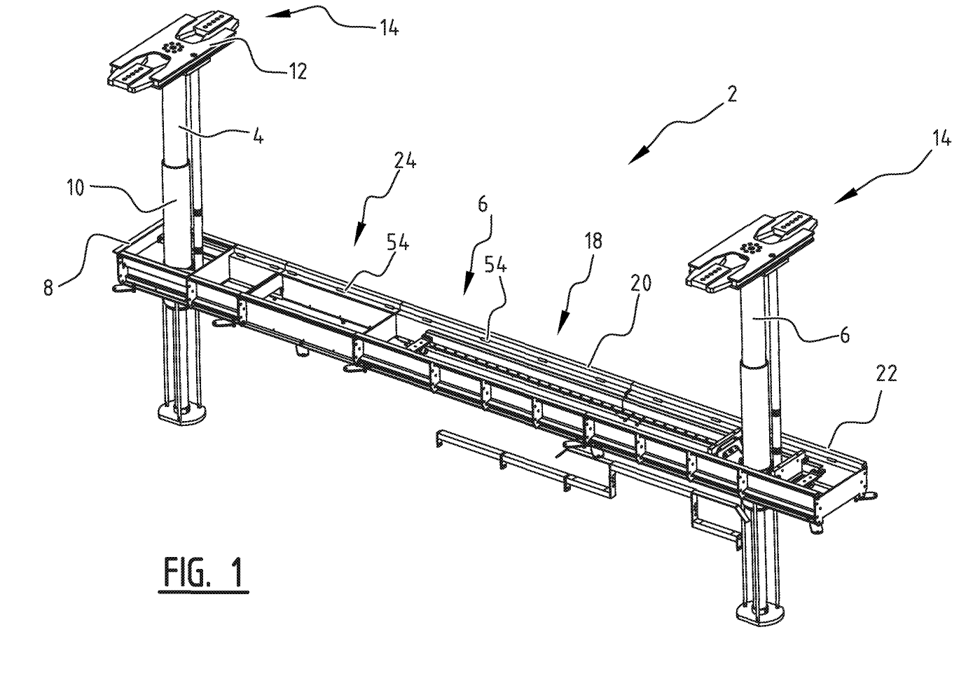

FIG. 1 shows an overview of the lifting system according to the invention;

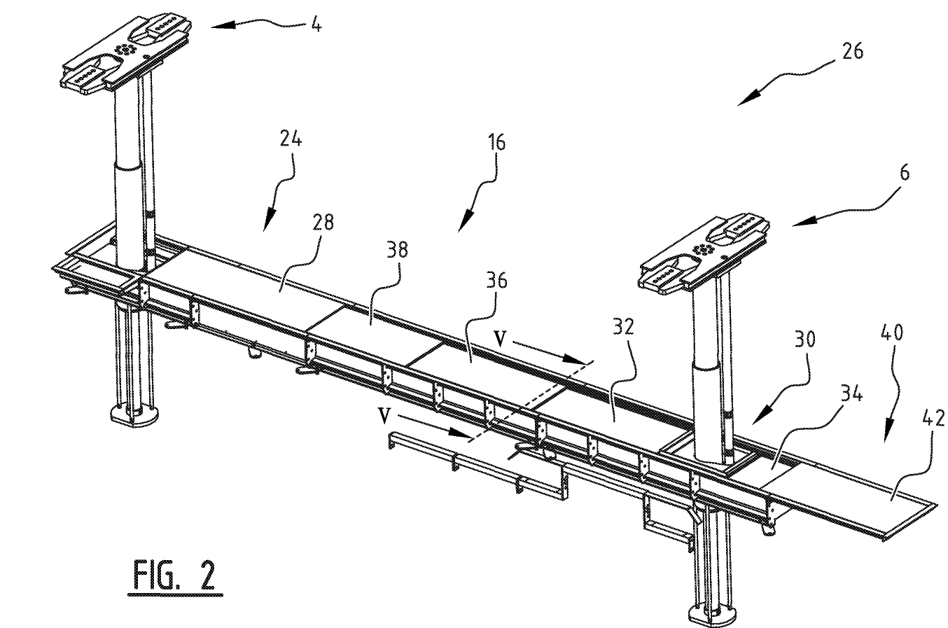

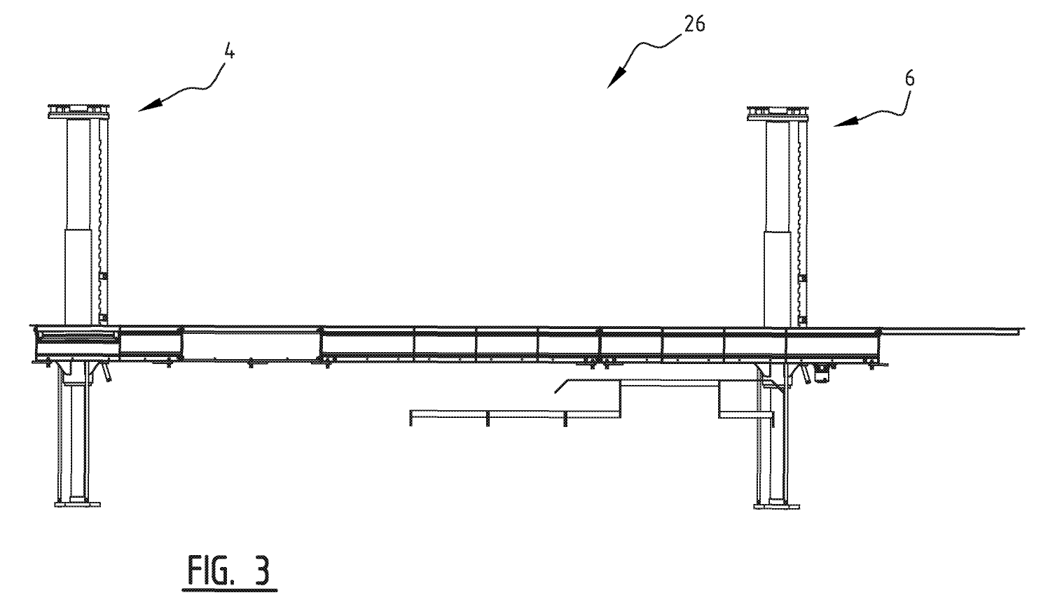

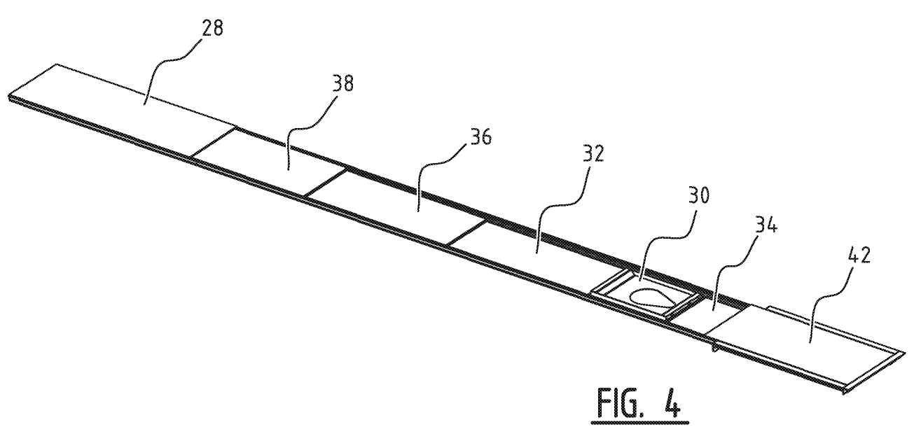

FIGS. 2-4 show a cover plate embodiment of the system according to the invention;

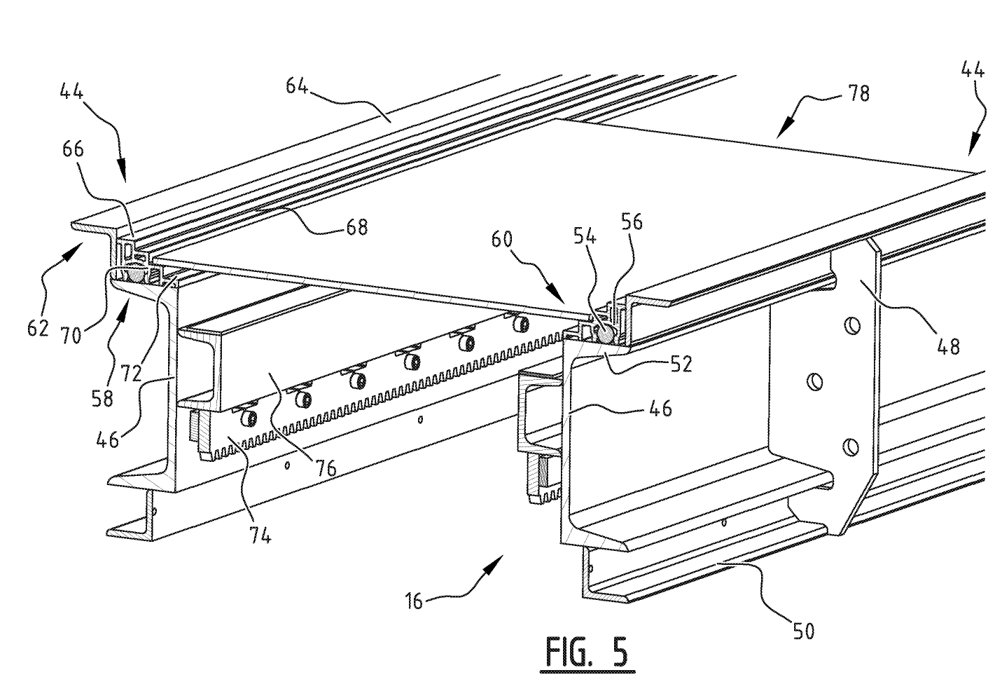

FIG. 5 shows a detail of the guidance structure of the embodiment of FIGS. 2-4;

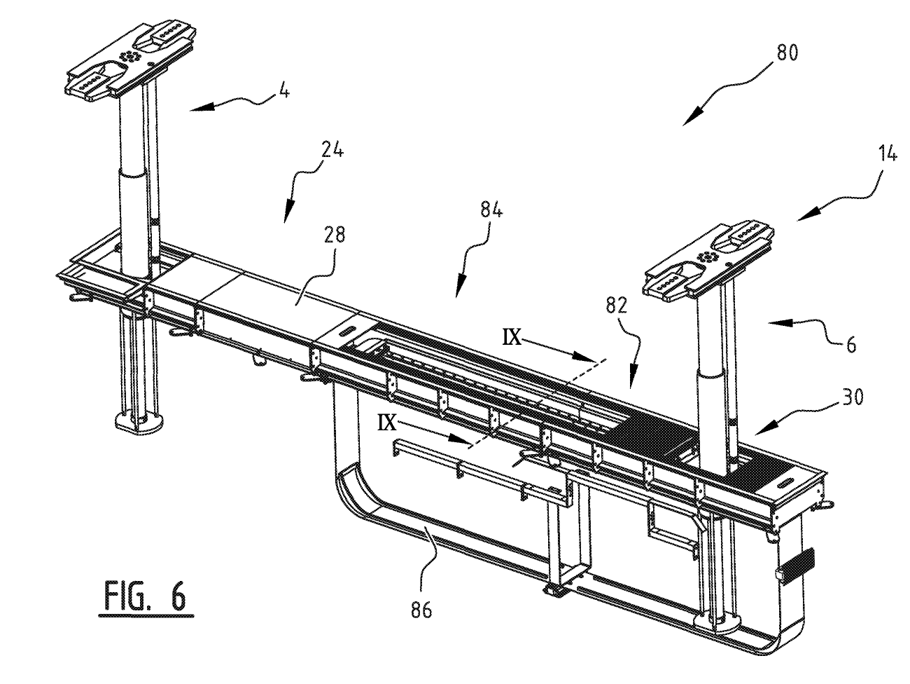

FIG. 6 shows an alternative embodiment with a rolling cover according to the invention;

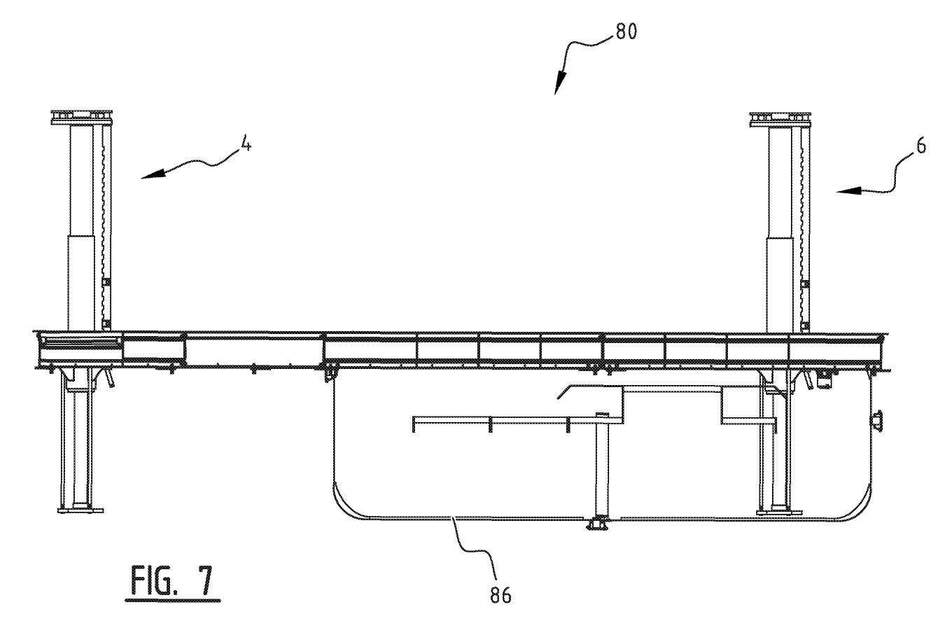

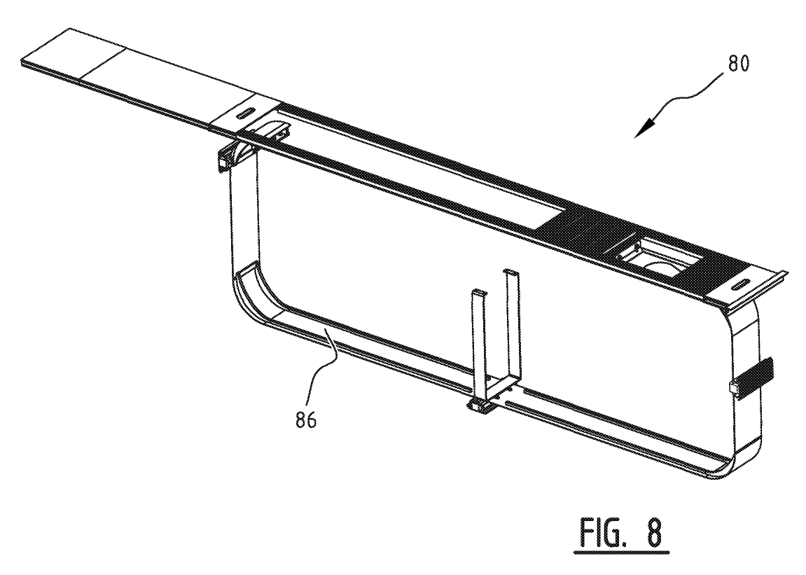

FIGS. 7-8 show details of the embodiment of FIG. 6;

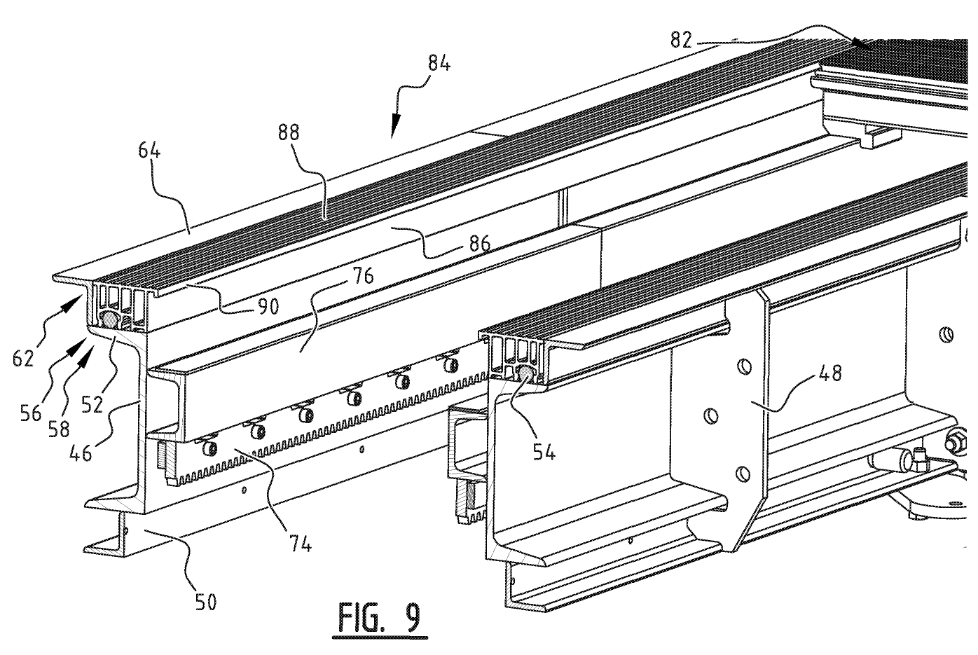

FIG. 9 shows the guidance structure of the embodiment of FIGS. 6-8;

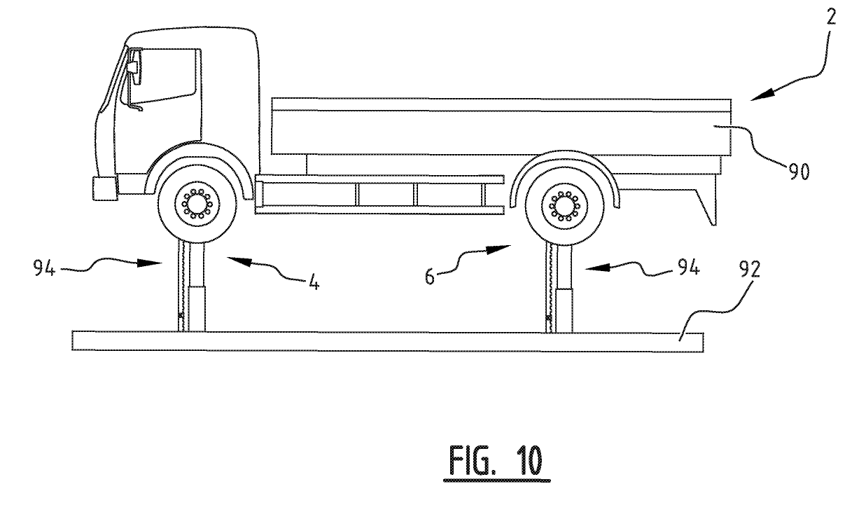

FIG. 10 shows a piston-type lifting system;

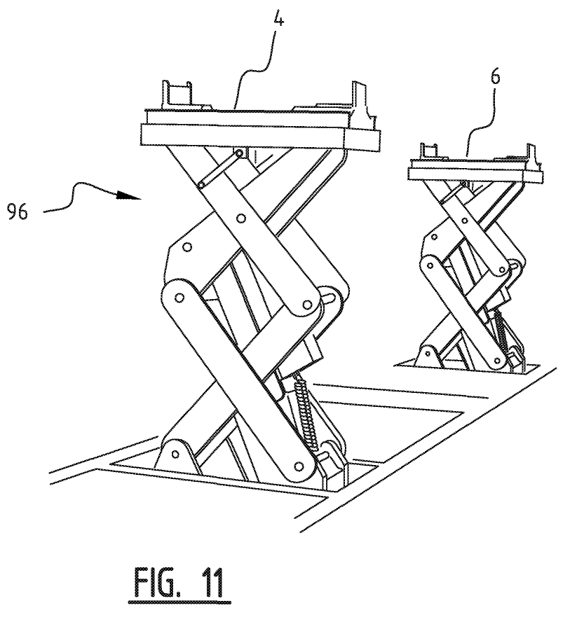

FIG. 11 shows a scissor-type lifting system; and

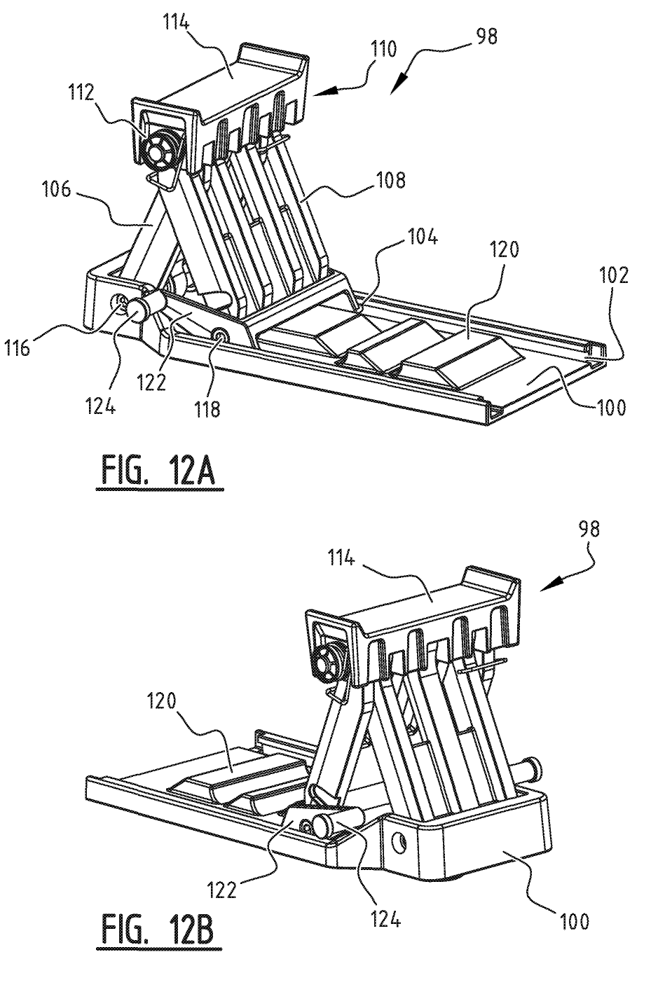

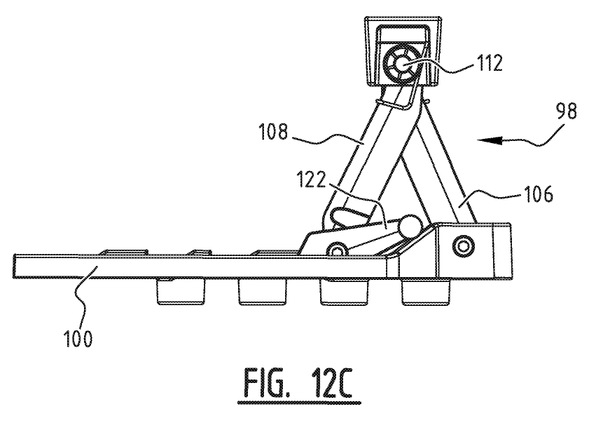

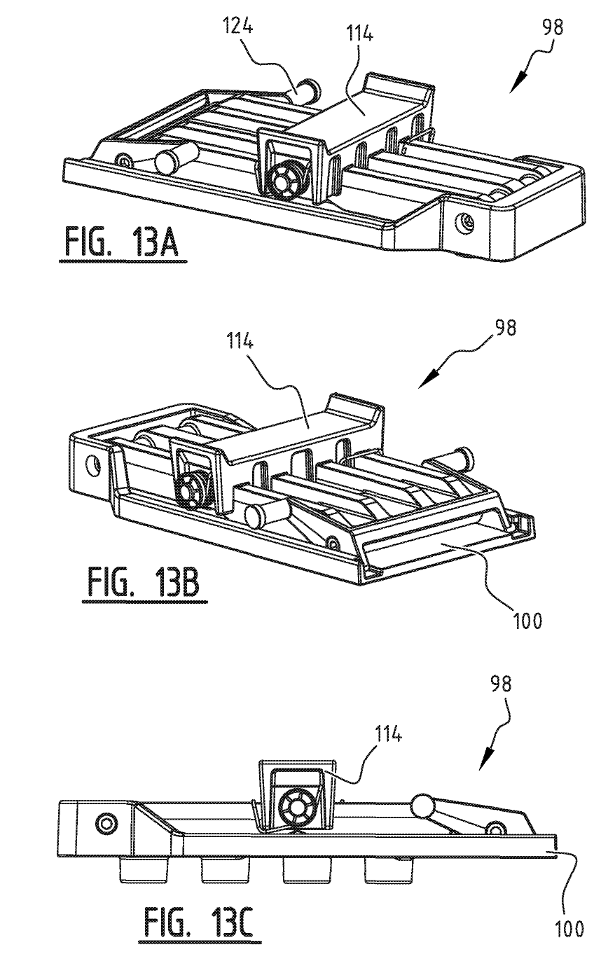

FIGS. 12 A-C and 13 A-C show an adapter for a lifting system according to the invention.

The following description is merely exemplary in nature and is in no way intended to limit the invention, its application, or uses. While the disclosure is described as having exemplary attributes and applications, the present disclosure can be further modified. This application is therefore intended to cover any variations, users, or annotations of the disclosure using its general principles. Further, this application is intended to cover such departures from the present disclosure as commonly known or customary practice of the skilled in the art to which this disclosure pertains and which fall within the limits of the appended claims. Accordingly, the following description of certain embodiments and examples should be considered merely exemplary and not in any way limiting.

The lifting system of the present invention is suitable for use with lifting systems comprising any number of lifting devices, including without limitation piston and scissor lifts and systems having one, two or four lifting devices. The lifting devices may achieve lifting and lowering capability by means known to those of skill in the art, including hydraulically, electrically, mechanically, and electromechanically. Lifting systems compatible with the present lifting system may be stationary and/or permanently affixed or attached to a certain location or may be mobile, or capable of being transported. With reference to the figures, alike element numbers refer to the same element between drawings.

An inground lifting system 2 (FIG. 1) comprises a piston-type fixed lifting device 4 and a movable lifting piston-type lifting device 6. Lifting devices 4, 6 are located on or in the floor of the working environment. The stationary lifting device 4 is provided in cassette or box 8 with a telescopic lifting cylinder 10. On top of cylinder 10 there is provided carrier 12 with axle carriers 14. It will be understood that depending on the dimensions and configurations of the axle of the vehicle different adapters can be provided with carrier 14.

The movable lifting device 6 moves in cassette or box 16 acting as pit frame and defining pit 18. In the illustrated embodiment pit 18 is defined by a first pit structure module 20 and a second pit structure module 22. Between the stationary pit structure 8 and extended pit structure 18 for movable lifting device 6 there is provided spacer module 24 defining the minimal distance between stationary lifting device 4 and movable lifting device 6.

Cover plate embodiment 26 (FIGS. 2-4) of the lifting system according to the invention (FIG. 2) comprises stationary lifting device 4 and movable lifting device 6. Lifting system 26 comprises spacer module 24 that is provided with a top plate 28 that is in use stationary positioned relative to the stationary lifting column 4. Movable lifting device 6 comprises a moving element or carrier 30 that on both sides is provided with a cover plate 32, 34, respectively. On the side directed towards stationary lifting device 4 cover plate 32 is connected to a second cover plate 36 and a third cover plate 38. It will be understood that the number of cover plates 32, 36, 38 depends on the dimensions of pit 16 and/or spacer module 24. Top plate 28 of spacer module 24 is capable of receiving and covering the movable cover plates 32, 36, 38 in case movable lifting device 6 is moved towards the stationary lifting device 4 such that a minimum distance remains. In the illustrated embodiment cover plate 32 may move underneath the intermediate cover plate 36. Both cover plates 32, 36 may move underneath cover plate 38 and the stack or set of cover plates 32, 36, 38 may move underneath top plate 28 of spacer module 24. On the other side of moveable lifting device 6 a second set of cover plates 34 is provided. This set of cover plates 34 may move underneath end module 40 that comprises a top plate 42 in a similar manner as compared to spacer module 24.

Modular cover guidance structure 44 (FIG. 5) is provided on beam element 46 of pit structure 16. In the illustrated embodiment guidance structure 44 is also connected to reinforcement plate 48 that is connected to beam 46 and profile 50. On the upper side edge 52 of beam 46 there is provided a number of snap rod elements 54 together defining a snap rod. Guidance structure 44 further comprises snap profile 56 with opening 58. Opening 58 is in use fixed over snap rod 54 such that a releasable connection 60 is achieved. Side edge 62 defines the dimensions in a width direction of pit structure 16. In the illustrated embodiment upper edge 64 substantially corresponds to the upper side of the floor of the work place. In the illustrated embodiment guidance structure 54 comprises four guiding surfaces. First surface 66 will carry top plate 28 while second surface 68, third surface 70 and fourth surface 72 enable guiding of movable cover plates 32, 36, 38. In addition, in the illustrated embodiment toothed gear-rack 74 is provided on carrier profile 76 enabling movement of movable lifting device 6. Contact elements 78 enable join movement of cover plates 32, 36, 38 dependent on the actual movement of the movable lifting device 6.

In an alternative embodiment, rolling cover lifting system 80 (FIGS. 6-8) comprises similar elements as described for plate cover embodiment 26 although rolling cover embodiment 80 comprises a rolling cover 82. In the illustrated embodiment modular cover guidance structure 84 comprises a continuous carrier 86 capable of guiding both sides of rolling cover 82 attached to both sides of moving element 30 of movable lifting device 6. Optionally, the ends of rolling cover 82 remain free or are connected.

Modular covering guidance structure 84 (FIG. 9) comprises a guiding profile 86 that is provided with snap profile 56 and opening 58 that in use snaps over snap rod 54 providing connection 60. In the illustrated embodiment guidance profile 86 is provided with upper surface 88 that potentially lies substantially flush with edge 64 and the upper surface of the floor of the working place. In the illustrated embodiment guidance structure 86 further comprises edge 90 preventing pulling up of rolling cover elements 82.

Lifting system 2 (FIG. 10) can be used to lift a vehicle 90 above floor 92 of the working place. In the illustrated embodiment lifting devices 4, 6 comprise piston type lifting devices 94.

Telescopic piston lifting device 94 can be replaced by scissor-type lifting devices 96 (FIG. 11). It will be understood that operation of lifting devices 94, 96 of the inground type is similar.

When vehicle 90 needs to be lifted lifting system 2 steers movable lifting device 6 to the desired location depended on the wheel base distance of vehicle 90. Lifting devices 4, 6 engage axles of vehicle 90 either directly by carriers 14 or indirectly through other assisting parts. Alternatively, vehicle 90 can be lifted by engaging other parts of the vehicle by lifting devices 4, 6. The number of lifting devices 4, 6 may depend on the size of the vehicle and/or number of axles of vehicle 90. It will be understood that either the front wheel axle or a rear wheel axle can be lifted by a stationary lifting device 4 during a lifting operation. During translational movement of movable lifting device 6 rolling cover 82 and/or sets of cover plates 32, 34, 36, 38 move over guidance structures 44, 84. Through the use of connection 60 a flexible connection for the guidance structures to the pit structure 16 is provided providing flexibility for the choice of cover type to the user. In addition, the releasable connection 60 enables the user to change the cover guidance and bring the cover type in accordance with his changed needs.

When designing a lifting system 2 the user specifies his needs involving the choice for a range of vehicles 90 that needs to be lifted with the lifting system 2. This design operation involves the choice of number and type of modular pit structures 20, 22, type of spacer module 24, end module 40 and stationary module 8. Next a plate-type cover embodiment 26, or rolling cover embodiment 80, or a combination thereof, will be selected and the according modular guidance structures will be defined. After the design operation is completed, the required components of lifting system 2 are manufactured, transported to the desired location, and installed at this desired location. This provides a flexible and relatively easy to install lifting system 2. Furthermore, the use of a modular structure enables relocating lifting system 2 in a relatively effective manner. The use of modular guidance structures 44, 84 is also applicable to already existing conventional lifting systems that are often custom made based on specific requirements. This provides additional flexibility to such conventional lifting systems.

Adapter 98 (FIGS. 12 A-C and 13 A-C) is provided on base plate 100. Base plate 100 comprises guides 102 that guide side edges 104. Adapter 98 comprises a first set of arms 106 and a second set of arms 108 that are connected on one of their ends with shaft 110 on which torsion spring 112 is arranged. Axle block 114 is carried by shaft 110. The other end of arm(s) 106 is arranged around shaft 116. The other end of the other arm(s) 108 is arranged around moveable shaft 118. Moveable shaft 118 can be moved in a direction substantially parallel to guides 102 and can engage to one of the blocks 120. This enables adjustment of the position of axle block 114. Around moveable shaft 118 lever arm 122 is provided. On the other end of lever arm 122 knob 124 is arranged. Knob 124 can be engaged by rod or stick or other element to remotely adjust the adapter. This also enables a user to adjust the adapter when the lifting system and the vehicle are already in their relative positions and ready for the lifting operation.

The present invention is by no means limited to the above-described preferred embodiments thereof. The rights sought are defined with the following claims, within the scope of which many modifications can be envisaged. For example, it is explicitly mentioned that combinations of the illustrated embodiments, including combination of individual features thereof, are possible.

1. An inground lifting system for lifting a vehicle, the system comprising:
a pit provided with one moveable first lifting device, the pit further comprising a pit frame;
a second lifting device; and
a cover configured for covering the pit,
wherein the pit frame comprises a modular cover guidance structure configured for guiding the cover.

2. The inground lifting system according to claim 1, wherein the guidance structure is releasably connected with a connection to the pit frame.

3. The inground lifting system according to claim 2, wherein the connection comprises a snap profile arranged on the guidance structure and a snap rod arranged on the pit frame.

4. The inground lifting system according to claim 1, wherein the cover comprises a rolling cover.

5. The inground lifting system according to claim 4, wherein the cover guidance structure comprises a continuous guiding structure.

6. The inground lifting system according to claim 1, wherein the cover comprises a number of plate covers.

7. The inground lifting system according to claim 6, wherein the plate covers comprise interacting contact elements configured for enabling joint movement of the plate covers.

8. The inground lifting system according to claim 4, wherein the cover comprises at least one rolling cover and one set of plate covers.

9. The inground lifting system according to claim 1, wherein the inground lifting system further comprises a spacer module that is arranged between the first and second lifting devices.

10. The inground lifting system according to claim 9, wherein the spacer module comprises a top plate and is configured for receiving one or more plate covers.

11. The inground lifting system according to claim 1, wherein the pit frame comprises a number of modular pit structures together defining the pit.

12. The inground lifting system according to claim 11, wherein at least some of the modular pit structures have a different length.

13. The inground lifting system according to claim 1, wherein at least one of the lifting systems comprises a base plate having an adjustable pick-up adapter configured for engaging a vehicle axle, with the adapter comprising a lever arm configured for adjusting a position of the adapter.

14. The inground lifting system according to claim 13, the adapter further comprising at least one spring element arranged for maintaining the adapter in a correct position.

15. The inground lifting system according to claim 1, wherein at least one of the lifting devices comprises a piston type lifting device.

16. The inground lifting system according to claim 1, wherein at least one of the lifting devices comprises a scissor type lifting device.

17. A method for configuring an inground lifting system, the method comprising the steps of:
defining the dimensions of the lifting system;
determining the number and type of modular pit structures together defining a pit of the lifting system;
placing and connecting the pit structures;
providing a modular cover guidance structure; and
positioning a cover.

18. The inground lifting system according to claim 3, wherein the cover comprises a rolling cover.

19. The inground lifting system according to claim 3, wherein the cover comprises a number of plate covers.

20. The inground lifting system according to claim 5, wherein the cover comprises at least one rolling cover and one set of plate covers.
